(19) United States
(12) Patent Application Publication
(10) Pub. No.: US 2005/0132380 A1
(43) Pub. Date: Jun. 16, 2005

(54) Method for hiding latency in a task-based library framework for a multiprocessor environment

(75) Inventor: Alex Chughen Chow, Austin, TX (US)

Correspondence Address: Gregory W. Carr, 670 Founders Square, 900 Jackson Street, Dallas, TX, 75202, US

(73) Assignee: International Business Machines Corporation, Armonk, NY (US)

(21) Appl. No.: 10/733,840

(22) Filed: Dec. 11, 2003

(51) Int. Cl. G06F 9/00

(52) U.S. Cl. 718/105

(57) ABSTRACT

A task-based library framework for load balancing using a system task queue in a tightly-coupled multiprocessor system. The system memory holds a queue of system tasks. The library processors fetch tasks from the queue for execution. The library processors fetch the tasks when they have a light load. A library processor can fetch a task while executing another task.

### TECHNICAL FIELD

The invention relates generally to multiprocessor environments and, more particularly, to a task-based library framework for dynamic load balancing in a multiprocessor environment, and to a method of latency hiding in this framework.

### BACKGROUND

A multiprocessor system executes a program faster than a single processor of the same speed because the multiple processors work simultaneously on the program. In such a system, programs are subdivided into tasks and the resultant tasks are assigned to processors. To take maximum advantage of a multiprocessor system, it is necessary to have all processors working simultaneously when any is. Load balancing is the attempt to evenly divide the tasks or workload among the processors. In traditional methods of load balancing, each processor has a queue of tasks. A central task-distributor assigns each new task on arrival to the queue for a processor. Some standard methods are round-robin, random, and assessment of how busy the processors are. In standard methods, the central distributor tries to predict the future to assess how long each processor requires to complete the tasks in its queue. The distributor's assessment is not always accurate, however. As a result, some processors sometimes have long queues of tasks while others are idle. Consequently, execution of the program is delayed.

In addition, the central distributor may be heavily burdened with the distributing of the tasks to the processors. Finally, there may be a delay in latency in task-loading or taking a task from the central distributor and loading it into a processor.

Therefore, there is a need for a method of load balancing in a multiprocessor system, that more evenly balances the load among the processors than traditional methods, does not burden the central distributor, and reduces the latency in task-loading.

### SUMMARY OF THE INVENTION

The present invention provides a task-based library framework for load balancing using a system task queue in a tightly-coupled multiprocessor system. The system memory holds a queue of system tasks. The library processors fetch tasks from the queue for execution.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 schematically depicts a tightly-coupled multiprocessor system with a task-based library framework and library processors;

FIG. 2 illustrates a library processor with double buffer for holding tasks;

FIG. 3 depicts a flow diagram of the subdivision of tasks into subtasks and the assignment of the subtasks to the library processors; and

FIG. 4 depicts a flow diagram which illustrates the loading of tasks onto a library processor.

### DETAILED DESCRIPTION

In the following discussion, numerous specific details are set forth to provide a thorough understanding of the present invention. However, it will be apparent to those skilled in the art that the present invention may be practiced without such specific details. In other instances, well-known elements have been illustrated in schematic or block diagram form in order not to obscure the present invention in unnecessary detail.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

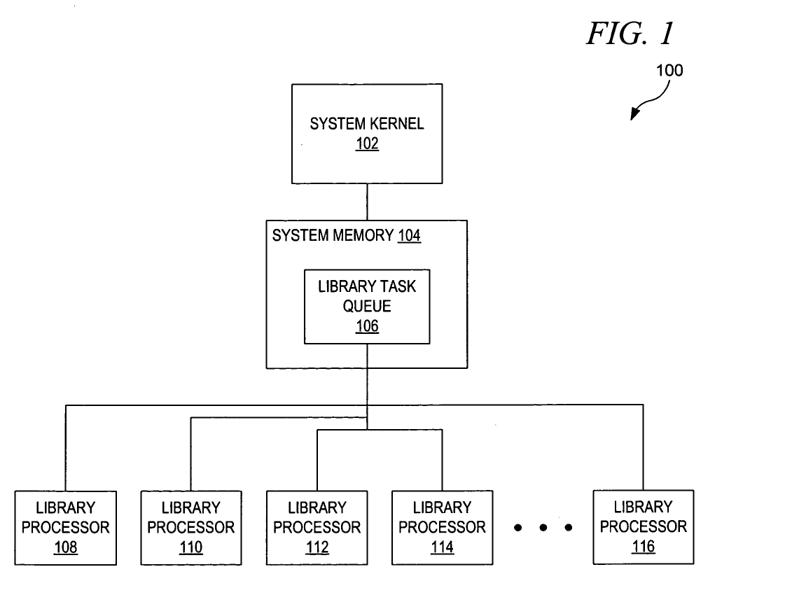

Referring to FIG. 1 of the drawings, the reference numeral 100 generally designates a tightly-coupled multiprocessor system with a task-based library framework. The system 100 comprises a system kernel 102, a system memory 104, and a number of library processors, 108, 110, 112, 114, and 116. The ellipsis indicates that the system 100 can comprise additional library processors. The system memory comprises a queue of tasks 106 to be assigned to the library processors (library task queue 106). Each library processor has access to the library task queue 106. When tasks arrive at the system kernel 102 for processing, they are subdivided into subtasks and placed into the library task queue 106. The library processors 108, 110, 112, 114, and 116 fetch the subtasks from the library task queue 106.

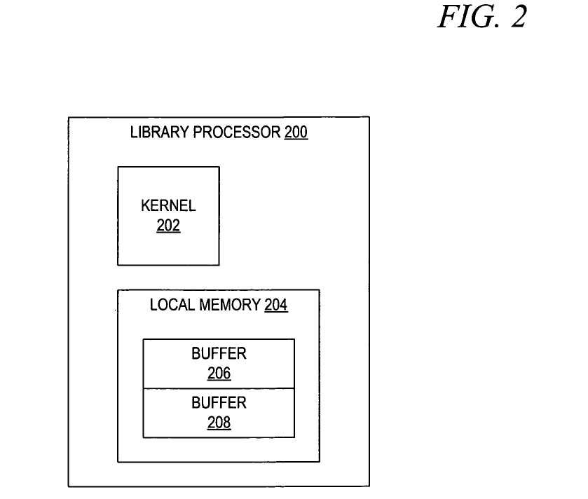

Referring to FIG. 2 of the drawings, illustrated is a library processor 200. It comprises a kernel 202, and a local memory 204. The local memory comprises buffers 206 and 208. When the library processor fetches a task from the library task queue 106, it loads it into one of the buffers 206 or 208. The library processor 200 can execute a task contained in one of the buffers while it is loading a task into the other buffer. As a result, the latency of task-loading is avoided. In addition, the library processor 200 shares in the work of the distribution of tasks from the library task queue 106. Thus, a heavy burden on a centralized task distributor is avoided.

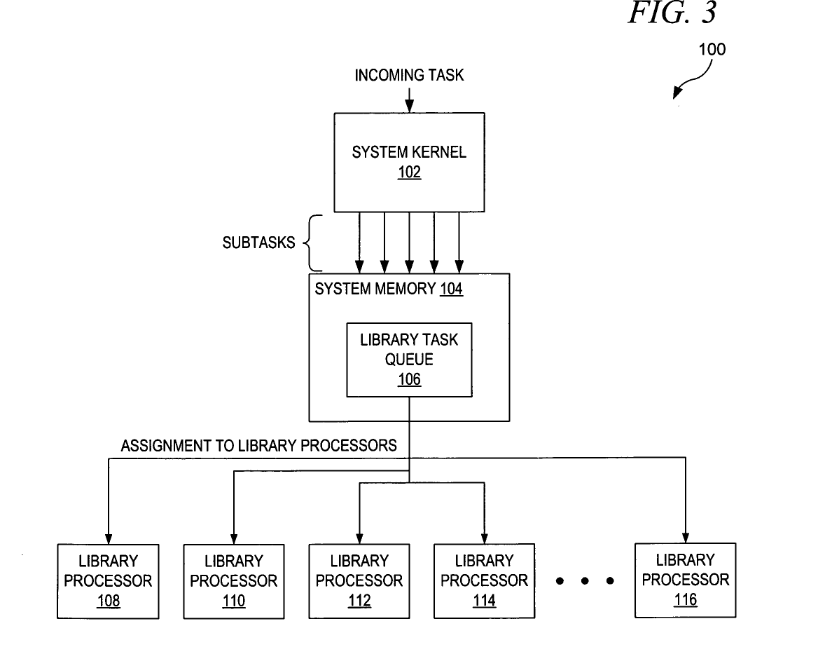

Referring to FIG. 3 of the drawings, illustrated is a flow chart of the subdivision of tasks into subtasks and their distribution to the library processors. An incoming task arrives at the system kernel 102. A thread of the main process (or a different process) submits the task to the system kernel 102 and blocks on a semaphore until the task is finished, when all the subtasks are finished and the semaphore is unblocked by the system kernel 102. In a server environment, the number of the processes is large enough to keep all the library processors 108, 110, 112, 114, and 116 busy and thus achieve the optimal through-put.

The task is subdivided into subtasks, which are placed in the library task queue 106. The library processors 108, 110, 112, 114, and 116 fetch the subtasks from the library task queue 106 into their buffers 206 and 208, process the tasks, return the results to the library task queue 106, and mark the results done. The system kernel 102 will “poll” for the results and status of the set of related tasks. The data structure tracking subtasks is shared by the system kernel 102 and the library processors 108, 110, 112, 114, or 116 that work on the subtasks. To ensure that all the library processors 108, 110, 112, 114, and 116 are working, the number of independent subtasks is larger than the number of available library processors.

For this method of subdividing tasks and distributing them to library processors to be effective, the multiprocessing system 100 must be tightly coupled. The time required for moving a task from the library task queue 106 to a library processor 108, 110, 112, 114, or 116 must not be substantially longer than the time to complete a task. Otherwise, there would be a delay while a task was being loaded in a library processor. One embodiment uses specially-designed communications channels to speed up the loading of tasks from the library task queue 106 to the library processors 108, 110, 112, 114, and 116.

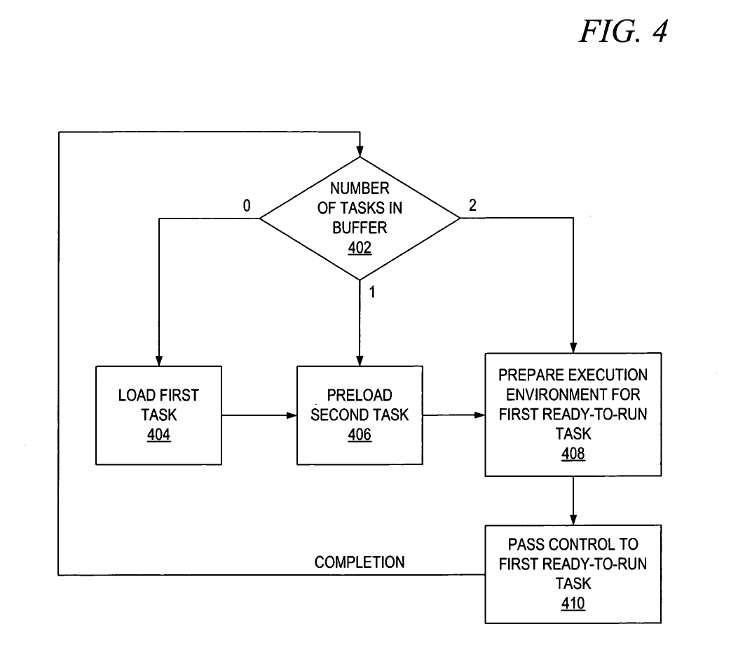

Now referring to FIG. 4, shown is a flow diagram which illustrates the loading of tasks onto a library processor. In step 402, the library processor kernel 202 checks the number of tasks residing in the buffer. If two tasks are residing, in step 408, the library processor kernel 202 prepares the execution environment for the first ready-to-run task. In step 410, the library processor kernel 202 passes control to the first ready-to-run task for execution. Upon completion of the task, the process returns to step 402.

If one task is residing in a buffer, in step 406, the library processor kernel 202 preloads a second task. Then, the process then goes to step 408. The new task from the library task queue 106 is loading while the old task is executing. As a result, the latency of loading is reduced or completely eliminated. Several mechanisms enable the simultaneous loading of a new task while the old task is executing. One such mechanism is a DMA mechanism that loads the new task. If there is no task in the library task queue 106 at step 406, the library processor kernel 202 executes the task in the buffer by proceeding to steps 408 and 410.

If no tasks are residing in the buffer, in step 404, the library processor kernel 202 fetches a task from the library task queue 106 and returns to step 402. If there is no task in the library task queue 106, the process waits until there is a task.

Steps 404 and 406 are where the load balancing occurs. The library processors 108, 110, 112, 114, or 116 fetch tasks from the library task queue 106 in these steps. Since a library processor 108, 110, 112, 114, or 116 fetches tasks only when there is at most one task in the buffers, the load on a library processor is never more than two tasks, one of which is executing. As a result, the load is evenly balanced. No library processor 108, 110, 112, 114, or 116 ever has more than one task in its buffers 206 and 208 awaiting execution while another library processor 108, 110, 112, 114, or 116 is idle.

To assure synchronicity, some bookkeeping steps are needed, which were glossed over above. When a task is fetched from the library task queue 106 at step 404 or step 406, the library task queue 106 is locked, the task to be fetched is marked ‘working’, and the library task queue 106 is unlocked. When a task has been processed, at the completion of step 410, the library task queue 106 is locked, the result of the task is updated and the task marked done, and the library task queue 106 is unlocked.

In one embodiment, the library processors 108, 110, 112, 114, and 116 use DMA mechanisms to load the task. The DMA mechanisms all share the same synchronization scheme/atomic access to the library task queue 106, thus enabling the transfer of a task from the library task queue 106 to one and only one library processor 108, 110, 112, 114, or 116.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for load balancing in a tightly-coupled multiprocessor computer system comprising the steps of:
placing a plurality of tasks into a centralized task queue; and
distributing the plurality of tasks in the centralized task queue to a plurality of library processors, wherein at least one task from the plurality of tasks in the centralized task queue is distributed to at least one of the plurality of library processors when the library processor has at least one empty task buffer.

2. The method of claim 1, further comprising distributing the task from the plurality of tasks in the centralized task queue to the one of the plurality of library processors when the one of the plurality of library processors has one or two empty task buffers, and wherein the one of the plurality of library processors has exactly two task buffers.

3. The method of claim 1, further comprising distributing the task from the plurality of tasks in the centralized task queue to the one of a plurality of library processors when the one of a plurality of library processors has all of its task buffers empty; that is, when load of the one of a plurality of library processors is zero tasks.

4. The method of claim 1, further comprising distributing the task from the plurality of tasks in the centralized task queue to the one of the plurality of library processors by the one of a plurality of library processors fetching it from the centralized task queue.

5. The method of claim 4, further comprising distributing the task from the plurality of tasks in the centralized task queue to the one of the plurality of library processors by the one of the plurality of library processors fetching it from the centralized task queue when the load of the one of a plurality of library processors is zero or one tasks.

6. The method of claim 4, further comprising distributing the task from the plurality of tasks in the centralized task queue to the one of the plurality of library processors by the one of the plurality of library processors fetching it from the centralized task queue when the load of the one of a plurality of library processors is zero tasks.

7. A method for avoiding latency in the distribution of a task from a centralized task queue to a library processor with a plurality of buffers, comprising the steps of:
preloading the task from the centralized task queue to an empty buffer of the plurality of buffers of the library processor; and
passing control to another task, ready for execution, contained in another buffer of the plurality of buffers of the library processor.

8. The method of claim 7, wherein the library processor has exactly two buffers for holding tasks.

9. A system for load balancing in a tightly-coupled multiprocessor computer system comprising
a system kernel;
a library task queue coupled to the kernel; and
a plurality of library processors coupled to the library task queue, wherein the system is configured for the system kernel to place tasks to be performed by the plurality of library processors into the library task queue.

10. The system of claim 9, wherein at least one of the plurality of library processors further comprises a library processor kernel and one or more task buffers, and wherein the system is further configured for a task placed in the library task queue to be distributed to one of the plurality of library processors when the library processor has at least one empty task buffer.

11. The system of claim 10, wherein the one of the plurality of library processors has exactly two task buffers.

12. The system of claim 10, wherein the system kernel is comprised of a single processor.

13. The system of claim 10, wherein the system kernel is comprised of a plurality of processors.

14. The system of claim 10, wherein the system is further configured for the task placed in the library task queue to be distributed to the one of a plurality of library processors by the one of the plurality of library processors fetching it from the library task queue.

15. A computer program product for load balancing in a tightly-coupled multiprocessor computer system, the computer program product having a medium with a computer program embodied thereon, the computer program comprising:
computer code for placing a plurality of tasks into a centralized task queue; and
computer code for distributing the plurality of tasks in the centralized task queue to a plurality of library processors;
wherein a task from the plurality of tasks in the centralized task queue is distributed to one of the plurality of library processors when the library processor has at least one empty task buffer.

16. The computer program product of claim 15, further comprising computer code for distributing the task from the plurality of tasks in the centralized task queue to the one of the plurality of library processors when the one of the plurality of library processors has one or two empty task buffers, and wherein the one of the plurality of library processors has exactly two task buffers.

17. The computer program product of claim 15, further comprising computer code for distributing the task from the plurality of tasks in the centralized task queue to the one of a plurality of library processors when the one of a plurality of library processors has all of its task buffers empty; that is, when load of the one of a plurality of library processors is zero tasks.

18. The computer program product of claim 15, further comprising computer code for distributing the task from the plurality of tasks in the centralized task queue to the one of the plurality of library processors by the one of a plurality of library processors fetching it from the centralized task queue.

19. The computer program code of claim 18, further comprising computer code for distributing the task from the plurality of tasks in the centralized task queue to the one of the plurality of library processors by the one of the plurality of library processors fetching it from the centralized task queue when the load of the one of a plurality of library processors is zero or one tasks.

20. The computer program code of claim 18, further comprising computer code for distributing the task from the plurality of tasks in the centralized task queue to the one of the plurality of library processors by the one of the plurality of library processors fetching it from the centralized task queue when the load of the one of a plurality of library processors is zero tasks.

21. A computer program product for avoiding latency in the distribution of a task from a centralized task queue to a library processor with a plurality of buffers, the computer program product having a medium with a computer program embodied thereon, the computer program comprising:
computer program code for preloading the task from the centralized task queue to an empty buffer of the plurality of buffers of the library processor; and
computer program code for passing control to another task, ready for execution, contained in another buffer of the plurality of buffers of the library processor.

22. The computer program code of claim 21, wherein the library processor has exactly two buffers for holding tasks.
